(19) United States
(12) Patent Application Publication
(10) Pub. No.: US 2016/0075947 A1
(43) Pub. Date: Mar. 17, 2016

(54) NEMATIC LIQUID CRYSTAL COMPOSITION AND LIQUID CRYSTAL DISPLAY ELEMENT USING SAME

(71) Applicant: DIC CORPORATION, Itabashi-ku, Tokyo (JP)

(72) Inventors: Go SUDO, Saitama (JP); Shotaro KAWAKAMI, Saitama (JP)

(73) Assignee: DIC CORPORATION, Tokyo (JP)

(21) Appl. No.: 14/773,019

(22) PCT Filed: Feb. 27, 2014
(86) PCT No.: PCT/JP2014/054921

§ 371 Date: Nov. 20, 2015

(30) Foreign Application Priority Data
Mar. 6, 2013 (JP) 2013-043990

(51) Int. Cl. C09K 19/30; C09K 19/02; C09K 19/54

(52) U.S. Cl. CPC C09K 19/3066; C09K 19/3003; C09K 19/542; C09K 19/0216; C09K 2019/3004; C09K 2019/3009; C09K 2019/301; C09K 2019/3016; C09K 2019/548

(57) ABSTRACT

The present invention relates to a nematic liquid crystal composition with negative dielectric anisotropy (Δ∈) useful as a liquid crystal display material, and to a liquid crystal display device using the composition.

The liquid crystal composition of the present invention provides a liquid crystal composition that has sufficiently low viscosity (η), sufficiently low rotational viscosity (γ1), high elastic modulus (K₃₃), and negative dielectric anisotropy (Δ∈) with a large absolute value without decreasing the refractive index anisotropy (Δn) and nematic phase-isotropic liquid phase transition temperature (Tₙᵢ). A liquid crystal display device of VA-mode or the like that uses this composition is also provided, which has less or no display failures.

The liquid crystal display device that uses the liquid crystal composition of the present invention is useful as an active-matrix-driving liquid crystal display device and can be used as a liquid crystal display device of VA-mode PSVA-mode, or the like.

### TECHNICAL FIELD

The present invention relates to a nematic liquid crystal composition with negative dielectric anisotropy (Δ∈) useful as a liquid crystal display material, and to a liquid crystal display device using the composition.

### BACKGROUND ART

Liquid crystal display devices are being used in watches, calculators, various home electrical appliances, measurement instruments, automobile panels, word processors, electronic organizers, printers, computers, televisions, etc. Representative examples of the liquid crystal display modes include a TN (twisted nematic) mode, a STN (super twisted nematic) mode, a DS (dynamic scattering) mode, a GH (guest-host) mode, an IPS (in-plane switching) mode, an OCB (optical compensation birefringence) mode, an ECB (electrically controlled birefringence) mode, a VA (vertical alignment) mode, a CSH (color super homeotropic) mode, and FLC (ferroelectric liquid crystal). Examples of the driving mode include static driving, multiplex driving, single matrix mode, and active matrix (AM) mode with which TFTs (thin film transistors), TFDs (thin film diodes), etc., are used for driving.

Among the display modes, the IPS mode, the ECB mode, the VA mode, the CSH mode, and the like are characterized in that they use liquid crystal materials with negative Δ∈. In particular, the VA display mode that involves AM driving is employed in display devices that require high speed and wide viewing angles, such as televisions, for example.

Nematic liquid crystal compositions used in such display modes as the VA mode are required to achieve low-voltage driving, high-speed response, and a wide operation temperature range. In other words, negative Δ∈ with a large absolute value, low viscosity, and a high nematic phase-isotropic liquid phase transition temperature (Tₙᵢ) are required. Furthermore, refractive index anisotropy (Δn) of the liquid crystal material must be adjusted within an appropriate range with respect to the cell gap (d) due to the setting of the product Δn×d. Since high-speed response is important in order for the liquid crystal display devices to be used in televisions and the like, liquid crystal materials desirably have low viscosity (η).

Heretofore, properties of liquid crystal compositions have been improved by studying various compounds with negative Δ∈ having a large absolute value.

There has been disclosed (refer to PTL 1) a liquid crystal composition with negative Δ∈ using the following liquid crystal compounds (A) and (B) having a 2,3-difluorophenylene skeleton:

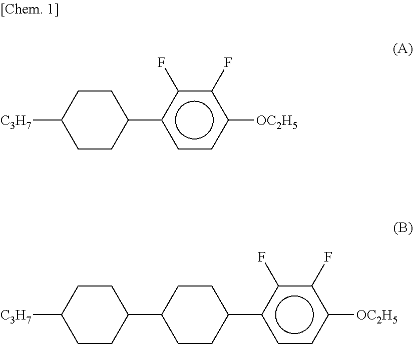

This liquid crystal composition uses liquid crystal compounds (C) and (D) as the compounds having approximately zero Δ∈ but fails to achieve viscosity sufficiently low for liquid crystal compositions that offer high-speed response such as one required by liquid crystal televisions and the like:

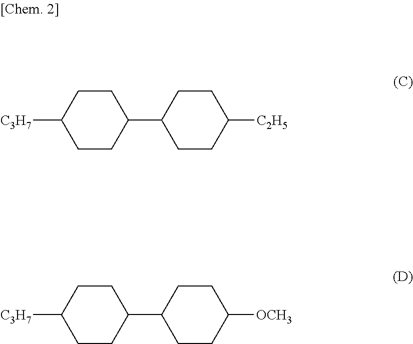

Liquid crystal compositions that use a compound represented by formula (E) have been disclosed; one such liquid crystal composition (refer to PTL 2) contains the liquid crystal compound (D) described above and has small Δn and another such liquid crystal composition (refer to PTL 3) contains a compound (alkenyl compound) intramolecularly having an alkenyl group such as a liquid crystal compound (F) for improving response speed. Thus, further studies have been needed to simultaneously achieve high Δn and high reliability.

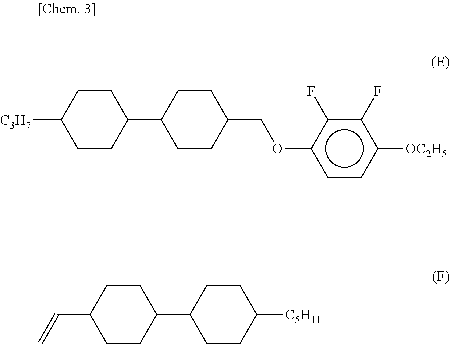

A liquid crystal composition that uses a compound represented by formula (G) has already been disclosed (refer to PTL 4). This liquid crystal composition also contains an alkenyl-compound-containing compound as the liquid crystal compound (F) described above, and thus an issue of likelihood of display failures such as ghosting and display nonuniformity remains.

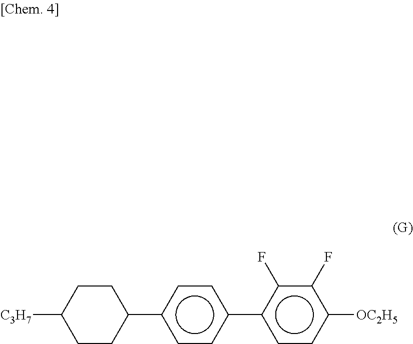

Influence of the liquid crystal composition containing an alkenyl compound on display failures has already been disclosed (refer to PTL 5). Generally, the decrease in the alkenyl compound content increases η of the liquid crystal composition and makes it difficult to achieve high-speed response. Thus, it has been difficult to achieve suppression of display failures and high-speed response simultaneously.

As discussed above, merely combining a compound that has negative Δ∈ and liquid crystal compounds (C), (D), and (F) has not readily led to development of a liquid crystal composition having negative Δ∈, with which high Δn and low η are achieved simultaneously and display failures are prevented or suppressed.

Although PTL 6 discloses that response speed of a homeotropic liquid crystal cell can be improved by using a liquid crystal material having a large index represented by (formula 1), the improvement has not been sufficient.

[Math. 1]

FoM=K₃₃·Δn²/γ1 (formula 1)

K₃₃: elastic modulus

Δn: refractive index anisotropy

γ1: rotational viscosity

In sum, a liquid crystal composition required to have high-speed response for use in liquid crystal televisions and the like has also been required to achieve sufficiently low viscosity (η), sufficiently low rotational viscosity (γ1), and high elastic modulus (K₃₃) without decreasing the refractive index anisotropy (Δn) and nematic phase-isotropic liquid phase transition temperature (Tₙᵢ).

### CITATION LIST

### Patent Literature

PTL 1: Japanese Unexamined Patent Application Publication No. 8-104869

PTL 2: EP Patent Application Publication No. 0474062 PTL 3: Japanese Unexamined Patent Application Publication No. 2006-37054

PTL 4: Japanese Unexamined Patent Application Publication No. 2001-354967

PTL 5: Japanese Unexamined Patent Application Publication No. 2008-144135

PTL 6: Japanese Unexamined Patent Application Publication No. 2006-301643

### SUMMARY OF INVENTION

### Technical Problem

An object of the present invention is to provide a liquid crystal composition that has sufficiently low viscosity (η), sufficiently low rotational viscosity (γ1), high elastic modulus (K₃₃), and negative dielectric anisotropy (Δ∈) with a large absolute value without decreasing the refractive index anisotropy (Δn) and nematic phase-isotropic liquid phase transition temperature (Tₙᵢ), and to also provide a high-display-quality, high-response-speed liquid crystal display device of a VA mode or the like that uses the liquid crystal composition and undergoes no or less display failures.

### Solution to Problem

The inventors of the present invention have studied various compounds and found that the issues described above can be resolved by combining particular compounds. Thus, the present invention has been made.

The present invention provides a liquid crystal composition that contains a compound represented by formula (I-1) as a first component:

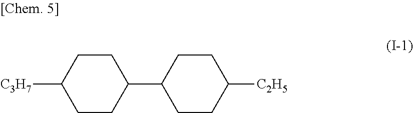

a compound represented by formula (I-2) as a second component:

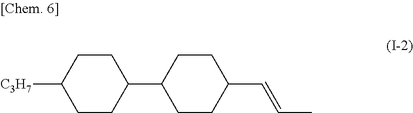

and a compound having negative dielectric anisotropy (Δ∈) whose absolute value is greater than 3 as a third component. A liquid crystal display device using the liquid crystal composition is also provided.

### Advantageous Effects of Invention

Since the liquid crystal composition of the present invention has sufficiently low viscosity (η), sufficiently low rotational viscosity (γ1), high elastic modulus (K₃₃), and negative dielectric anisotropy (Δ∈) with a large absolute value without decreasing the refractive index anisotropy (Δn) and nematic phase-isotropic liquid phase transition temperature (Tₙᵢ), a liquid crystal display device such as a VA mode device that uses the liquid crystal composition undergoes no or less display failures and exhibits high display quality and high response speed.

### DESCRIPTION OF EMBODIMENTS

The liquid crystal composition of the present invention contains, as a first component, 3% to 25% by mass, preferably 5% to 20% by mass, and most preferably 5% to 15% by mass of a compound represented by general formula (I-1). Specifically, the first component content is preferably 10% to 25% by mass in order to obtain low viscosity or low rotational viscosity, and is preferably 3% to 15% by mass if suppression of precipitation at low temperature is important.

As the second component, 3% to 20% by mass, preferably 5% to 15% by mass, and most preferably 5% to 10% by mass of the compound represented by general formula (I-2) is contained. Specifically, the second component content is preferably 10% to 20% by mass in order to obtain low viscosity or low rotational viscosity, and is preferably 3% to 10% by mass if suppression of precipitation at low temperature is important.

A compound having negative dielectric anisotropy (Δ∈) with an absolute value greater than 3 is contained as the third component. Specific examples thereof are compounds represented by general formula (II-1) and general formula (II-2).

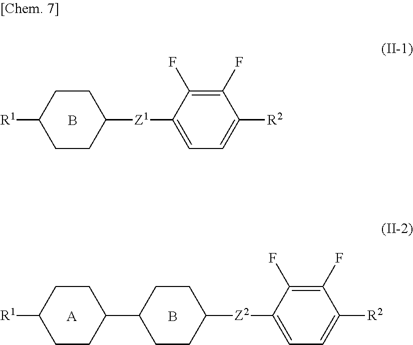

In the formulae, R¹ and R² each independently represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms; one —CH₂— or two or more nonadjacent —CH₂— in R¹ and R² may each independently be substituted with —O— and/or —S—; one or more hydrogen atoms in R¹ and R² may each independently be substituted with a fluorine atom or a chlorine atom; R¹ preferably represents an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms, more preferably represents an alkyl group having 1 to 5 carbon atoms or an alkenyl group having 2 to 5 carbon atoms, and yet more preferably represents an alkyl group having 1 to 3 carbon atoms or an alkenyl group having 3 carbon atoms (propenyl group); R² preferably represents an alkyl group having 1 to 5 carbon atoms, an alkoxyl group having 1 to 5 carbon atoms, or an alkenyloxy group and more preferably represents an alkyl group having 1 or 2 carbon atoms or an alkoxy group having 1 or 2 carbon atoms. In the formulae, ring A and ring B each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group and more preferably each independently represent a trans-1,4-cyclohexylene group or a 1,4-phenylene group. In the formulae, Z¹ and Z² each independently represent —OCH₂—, —CH₂O—, —CF₂O—, —OCF₂—, —CH₂CH₂—, —CF₂CF₂—, or a single bond, preferably each independently represent —CH₂O—, —CF₂O—, —CH₂CH₂—, —CF₂CF₂—, or a single bond, more preferably each independently represent —CH₂O—, —CH₂CH₂—, or a single bond, and most preferably each independently represent —CH₂O— or a single bond.

The number of compounds represented by general formula (II-1) and general formula (II-2) contained is 1 or more and is preferably 2 to 10. The content thereof is preferably 10% to 90% by mass, more preferably 20% to 80% by mass, and yet more preferably 30% to 70% by mass.

The liquid crystal composition of the present invention preferably simultaneously contains a compound represented by general formula (II-1) and a compound represented by general formula (II-2).

The compound represented by general formula (II-1) is specifically preferably a compound selected from the compounds represented by general formula (II-A1) to general formula (II-A4):

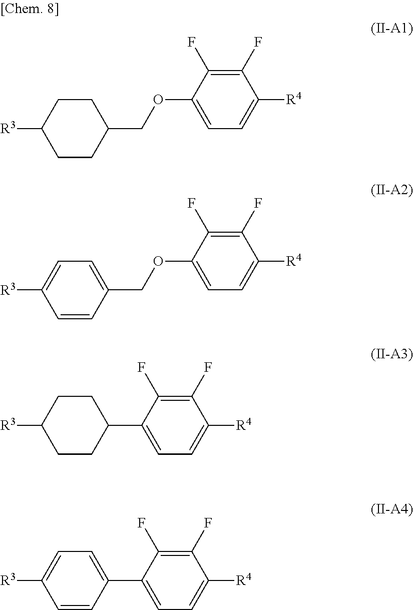

(In the formulae, R³ and R⁴ are each independently the same as R¹ and R²). A compound represented by general formula (II-A1), a compound represented by general formula (II-A3), and a compound represented by general formula (II-A4) are preferable. A compound represented by general formula (II-A1) and a compound represented by general formula (II-A4) are more preferable.

The compound represented by general formula (II-2) is a compound selected from compounds represented by general formula (II-B1) to general formula (II-B6)

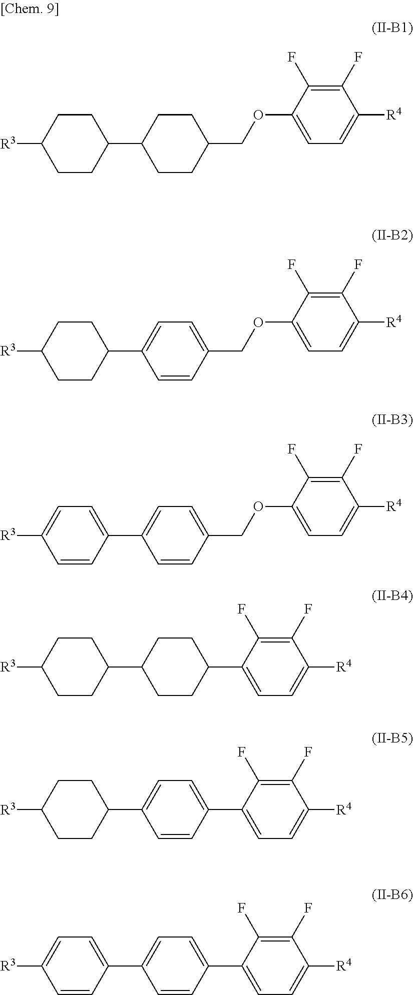

(In the formulae, R³ and R⁴ are each independently the same as R¹ and R²). A compound represented by general formula (II-B1), general formula (II-B3), general formula (II-B4), general formula (II-B5), or general formula (II-B6) is more preferable. A compound represented by general formula (II-B1) is most preferable.

Specifically, the third component is preferably a combination of general formula (II-A1) and general formula (II-B1), more preferably a combination of general formula (II-A1), general formula (II-B1), and general formula (II-A3), and yet more preferably a combination of general formula (II-A1), general formula (II-B1), and general formula (II-A4).

More specifically, the third component is preferably a combination of general formula (II-A3) and general formula (II-B4), more preferably a combination of general formula (II-A3), general formula (II-B4), and general formula (II-B5), and yet more preferably a combination of general formula (II-A3), general formula (II-B4), and general formula (II-B1).

More specifically, the third component is preferably a combination of general formula (II-A4) and general formula (II-B4), more preferably a combination of general formula (II-A4) and general formula (II-B1), yet more preferably a combination of general formula (II-A4), general formula (II-B1), and general formula (II-B5), and most preferably a combination of general formula (II-A4), general formula (II-B1), and general formula (II-B3).

The liquid crystal composition of the present invention preferably contains, as a fourth component, one or more compounds selected from general formula (III-A) to general formula (III-J):

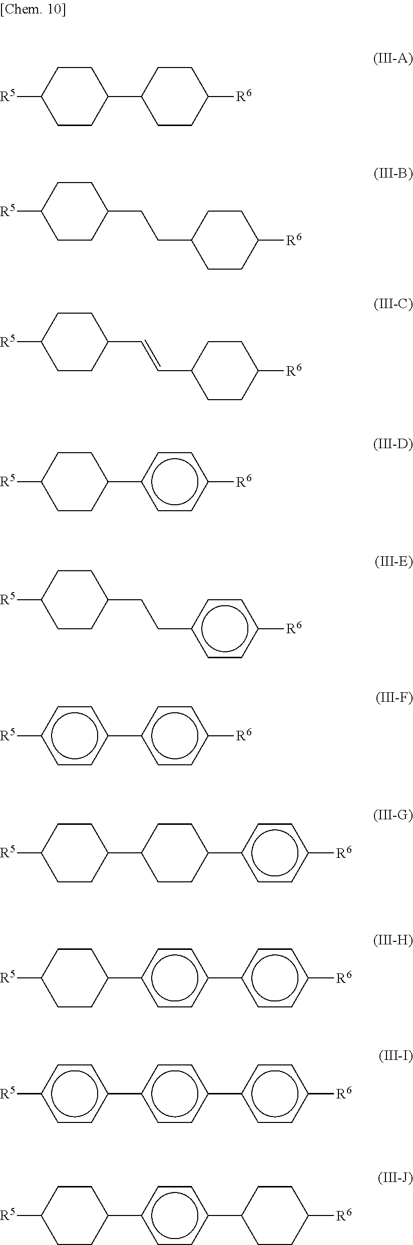

(In the formulae, R⁵ represents an alkyl group having 1 to 5 carbon atoms or an alkenyl group having 2 to 5 carbon atoms, R⁶ represents an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms). However, compounds represented by general formula (III-A) do not include the same compounds as those represented by formula (I-1) and formula (I-2).

The fourth component is preferably a compound selected from general formula (III-A), general formula (III-D), general formula (III-F), general formula (III-G), and general formula (III-H), more preferably a compound selected from general formula (III-A), general formula (III-F), general formula (III-G), and general formula (III-H), yet more preferably a compound selected from general formula (III-A), general formula (III-G), and general formula (III-H) yet more preferably a compound selected from general formula (III-A), general formula (III-F), and general formula (III-H), and most preferably a compound selected from general formula (III-A) and general formula (III-F).

In the compounds represented by general formula (III-D), general formula (III-G), and general formula (III-H), R⁵ preferably represents an alkyl group having 1 to 5 carbon atoms or an alkenyl group having 2 to 5 carbon atoms, and R⁶ preferably represents an alkyl group having 1 to 5 carbon atoms or an alkoxy group having 1 to 5 carbon atoms. R⁵ more preferably represents an alkenyl group having 2 to 5 carbon atoms and yet more preferably represents an alkenyl group having 2 or 3 carbon atoms. In the compound represented by general formula (III-F), R⁵ and R⁶ preferably each independently represent an alkyl group having 1 to 5 carbon atoms or an alkenyl group having 2 to 5 carbon atoms.

The liquid crystal composition of the present invention preferably contains a compound represented by general formula (III-A), which is a fourth component.

The liquid crystal composition of the present invention preferably contains a compound represented by general formula (III-F), which is a fourth component.

The liquid crystal composition of the present invention preferably simultaneously contains a compound represented by general formula (III-A) and a compound represented by general formula (III-F) which are fourth components.

The compound represented by general formula (III-A) preferably has R⁵ representing an alkenyl group having 2 carbon atoms and R⁶ representing an alkyl group having 3 carbon atoms.

The fourth component content is preferably 1% by mass to 40% by mass, preferably 5% by mass to 40% by mass, preferably 10% by mass to 40% by mass, and more preferably 20% by mass to 40% by mass.

The compound represented by general formula (III-F) preferably has R⁵ representing an alkyl group having 2 to 5 carbon atoms and R⁶ representing an alkyl group having 1 to 3 carbon atoms.

The fourth component content is preferably 1% by mass to 40% by mass and preferably 5% by mass to 40% by mass.

One or more compounds represented by general formula (V) may also be contained as additional components.

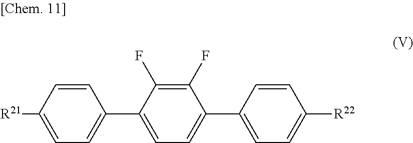

In the formula R²¹ and R²² each independently represent an alkyl group having 1 to 8 carbon atoms, an alkoxyl group having 1 to 8 carbon atoms, an alkenyl group having 2 to 8 carbon atoms, or an alkenyloxy group having 2 to 8 carbon atoms. An alkyl group having 1 to 5 carbon atoms or an alkenyl group having 2 to 5 carbon atoms is preferable.

One or more compounds represented by general formula (VIII-a), general formula (VIII-c), or general formula (VIII-d) may be contained as additional components.

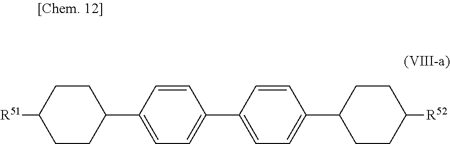

(In the formula, R⁵¹ and R⁵² each independently represent an alkyl group having 1 to 5 carbon atoms, an alkenyl group having 2 to 5 carbon atoms, or an alkoxy group having 1 to 4 carbon atoms.)

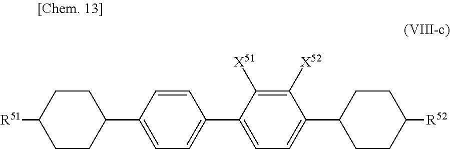

(In the formula, R⁵¹ and R⁵² each independently represent an alkyl group having 1 to 5 carbon atoms, an alkenyl group having 2 to 5 carbon atoms, or an alkoxy group having 1 to 4 carbon atoms; X⁵¹ and X⁵² each independently represent a fluorine atom or a hydrogen atom; and at least one selected from X⁵¹ and X⁵² represents a fluorine atom).

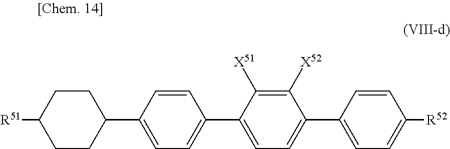

(In the formula, R⁵¹ and R⁵² each independently represent an alkyl group having 1 to 5 carbon atoms, an alkenyl group having 2 to 5 carbon atoms, or an alkoxy group having 1 to 4 carbon atoms; X⁵¹ and X⁵² each independently represent a fluorine atom or a hydrogen atom; and at least one selected from X⁵¹ and X⁵² represents a fluorine atom).

One or more compounds represented by general formula (V-9.1) to general formula (V-9.3) may be contained as additional components.

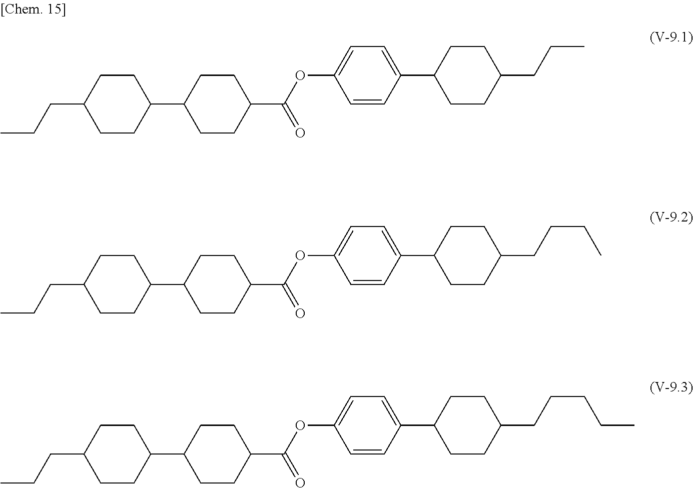

The liquid crystal composition of the present invention preferably simultaneously contains compounds represented by formula (I-1), formula (I-2), general formula (II-A1), and general formula (III-A), preferably simultaneously contains compounds represented by formula (I-1), formula (I-2), general formula (II-A3), and general formula (III-A), preferably simultaneously contains compounds represented by formula (I-1), formula (I-2), general formula (II-A4), and general formula (III-A), preferably simultaneously contains compounds represented by formula (I-1), formula (I-2), general formula (II-B1), and general formula (III-A), preferably simultaneously contains compounds represented by formula (I-1), formula (I-2), general formula (II-B3), and general formula (III-A), preferably simultaneously contains compounds represented by formula (I-1), formula (I-2), general formula (II-B4), and general formula (III-A), and preferably simultaneously contains compounds represented by formula (I-1), formula (I-2), general formula (II-B5), and general formula (III-A).

The liquid crystal composition of the present invention more preferably simultaneously contains compounds represented by formula (I-1), formula (I-2), general formula (II-A1), general formula (II-B1), and general formula (III-A), more preferably simultaneously contains compounds represented by formula (I-1), formula (I-2), general formula (II-A3), general formula (II-B5), and general formula (III-A), more preferably simultaneously contains compounds represented by formula (I-1), formula (I-2), general formula (II-A1), general formula (II-B4), and general formula (III-A), and more preferably simultaneously contains compounds represented by formula (I-1), formula (I-2), general formula (II-A1), general formula (II-B5), and general formula (III-A).

The liquid crystal composition of the present invention more preferably simultaneously contains compounds represented by formula (I-1), formula (I-2), general formula (II-A4), general formula (II-B5), and general formula (III-H) more preferably simultaneously contains compounds represented by formula (I-1), formula (I-2), general formula (II-A1), general formula (II-B1), and general formula (III-H) and more preferably simultaneously contains compounds represented by formula (I-1), formula (I-2), general formula (II-A1), general formula (II-B1), general formula (II-B3), and general formula (III-H).

The total content of the first component, the second component, the third component, and the fourth component in the liquid crystal composition of the present invention is preferably 70% to 100% by mass, more preferably 80% to 100% by mass, and most preferably 85% to 100% by mass.

The dielectric anisotropy (Δ∈) of the liquid crystal composition of the present invention at 25° C. is −2.0 to −8.0, preferably −2.0 to −6.0, more preferably −2.0 to −5.0, and most preferably −2.5 to −4.0.

The refractive index anisotropy (Δn) of the liquid crystal composition of the present invention at 20° C. is 0.08 to 0.14, preferably 0.09 to 0.13, and more preferably 0.09 to 0.12. Specifically, the refractive index anisotropy (Δn) is preferably 0.10 to 0.13 for a small cell gap and 0.08 to 0.10 for a large cell gap.

The viscosity (η) of the liquid crystal composition of the present invention at 20° C. is 10 to 30 mPa·s, preferably 10 to 25 mPa·s, and more preferably 10 to 22 mPa·s.

The rotational viscosity (γ₁) of the liquid crystal composition of the present invention at 20° C. is 60 to 130 mPa·s, more preferably 60 to 110 mPa·s, and most preferably 60 to 100 mPa·s.

The nematic phase-isotropic liquid phase transition temperature (Tₙᵢ) of the liquid crystal composition of the present invention is 60° C. to 120° C., more preferably 70° C. to 100° C., and yet more preferably 70° C. to 85° C.

The liquid crystal composition of the present invention may contain, in addition to the compounds described above, a common nematic liquid crystal, a smectic liquid crystal, a cholesteric liquid crystal, an antioxidant, an ultraviolet light absorber, a light stabilizer (HALS), an infrared absorber, a polymerizable monomer, and the like.

For example, the liquid crystal composition may contain 0.01% to 2% by mass of a polymerizable compound, such as a biphenyl derivative or a terphenyl derivative, as a polymerizable monomer. More specifically, one or more polymerizable compounds represented by general formula (M):

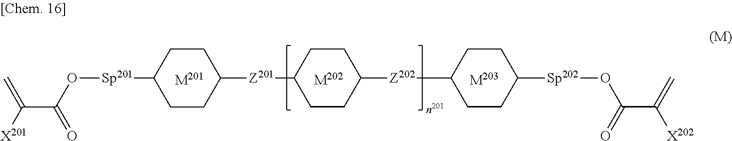

may be contained in the liquid crystal composition.

In general formula (M), X²⁰¹ and X²⁰² each independently represent a hydrogen atom, a methyl group, or a —CF₃ group. A diacrylate derivative with X²⁰¹ and X²⁰² both representing a hydrogen atom and a dimethacrylate derivative with X²⁰¹ and X²⁰² both representing a methyl group are preferable. A compound in which one represents a hydrogen atom and the other represents a methyl group is also preferable. While suitable compounds may be used according to the usage, the polymerizable compound represented by general formula (M) preferably has at least one methacrylate derivative or two methacrylate derivatives if the usage is for PSA display devices.

In general formula (M), Sp²⁰¹ and Sp²⁰² each independently represent a single bond, an alkylene group having 1 to 8 carbon atoms, or —O—(CH₂)ₛ— (where s represents an integer of 2 to 7 and the oxygen atom is to bond to a ring). At least one selected from Sp²⁰¹ and Sp²⁰² preferably represents a single bond for PSA mode liquid crystal display devices, a compound in which both Sp²⁰¹ and Sp²⁰² represent a single bond is preferable, and a compound with one of Sp²⁰¹ and Sp²⁰² representing a single bond and the other representing an alkylene group having 1 to 8 carbon atoms or —O—(CH₂)ₛ— is preferable. In such a case, an alkylene group having 1 to 4 carbon atoms is preferable and s is preferably 1 to 4.

In general formula (M), ring M²⁰¹, M²⁰², ring and ring M²⁰³ each independently represent a trans-1,4-cyclohexylene group (one —CH₂— or two or more nonadjacent —CH₂— in the group may each be substituted with —O— or —S—), a 1,4-phenylene group (one —CH═ or two or more nonadjacent —CH═ in the group may each be substituted with —N═), a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and hydrogen atoms in the group may be each independently substituted with a fluorine atom, a —CF₃ group, an alkyl group having 1 to 10 carbon atoms, an alkoxyl group having 1 to 10 carbon atoms, or any one of groups represented by formula (R-1) to formula (R-15):

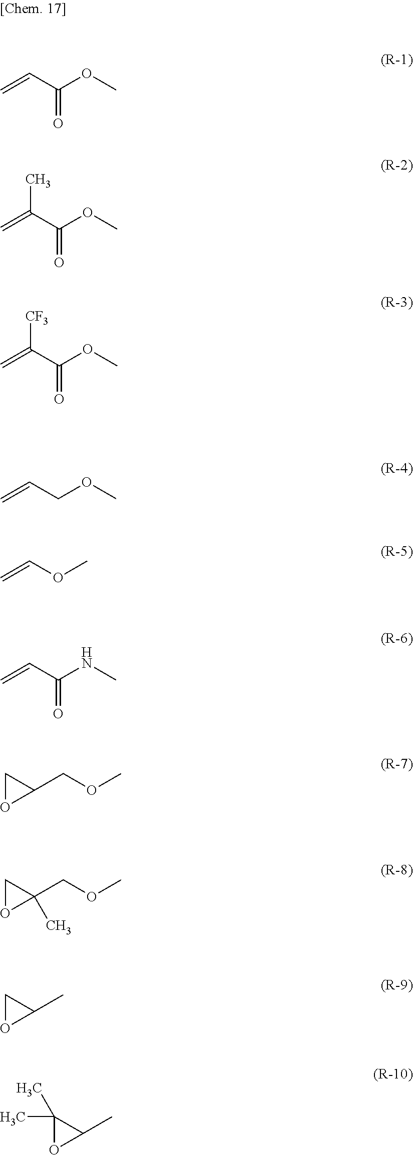

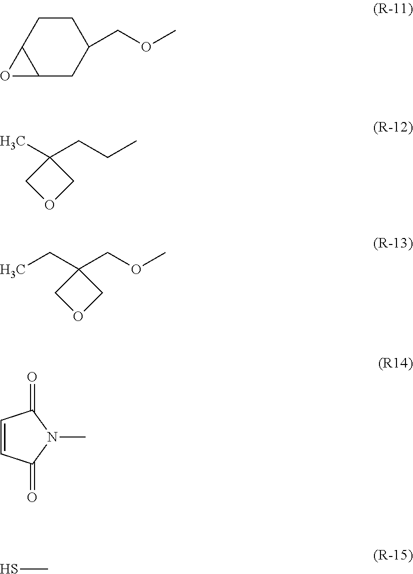

In general formula (M), Z²⁰¹ and Z²⁰² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond but preferably each independently represent —COO—, —OCO—, —CH═CH—COO—, —CH═CH—OCO—, —COO—CH═CH—, —OCO—CH═CH—, —COO—CH₂═CH₂—, —OCO—CH₂CH₂—, —CH₂CH₂—COO—, —CH₂CH₂—OCO—, —C≡C—, or a single bond, and more preferably each independently represent —COO—, —OCO—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, or a single bond.

In general formula (M), n²⁰¹ represents 0, 1, or 2 and preferably represents 0 or 1. However, when there are two or more rings M²⁰² and two or more Z²⁰², they may each be the same or different.

At least one polymerizable compound represented by general formula (M) may be contained. Preferably one to five and more preferably one to three polymerizable compounds represented by general formula (M) are contained.

The compounds represented by general formula (M) are preferably contained in an amount of 0.01% to 2.00% by mass, more preferably 0.05% to 1.00% by mass, and yet more preferably 0.10% to 0.50% by mass.

More specifically, when n²⁰¹ in general formula (M) is 0, the ring structure between Sp²⁰¹ and Sp²⁰² is preferably one represented by any one of formula (XXa-1) to formula (XXa-5), more preferably formula (XXa-1) to formula (XXa-3), and yet more preferably formula (XXa-1) and formula (XXa-2). Each of the two ends in each formula is to bond to Sp²⁰¹ or Sp²⁰².

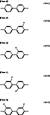

The polymerizable compounds represented by general formula (M) including these skeletons exhibit optimum anchoring force for PSA-mode liquid crystal display devices after polymerization and a satisfactory alignment state is yielded. Thus, display nonuniformity is suppressed or prevented.

In view of the above, compounds represented by formula (XX-1) to general formula (XX-10) are preferable as the polymerizable monomer. Compounds represented by formula (XX-1) to formula (XX-4) are more preferable.

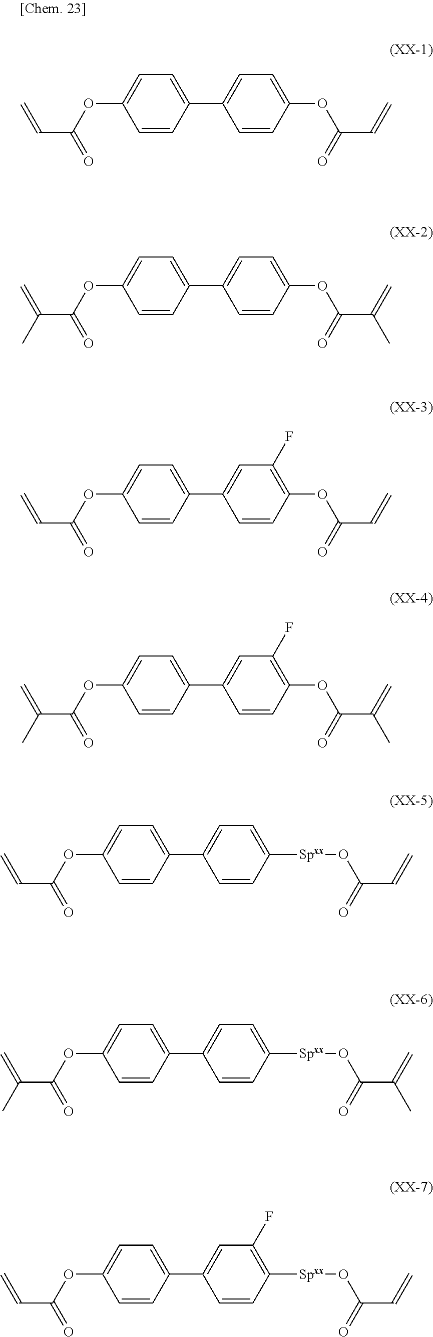

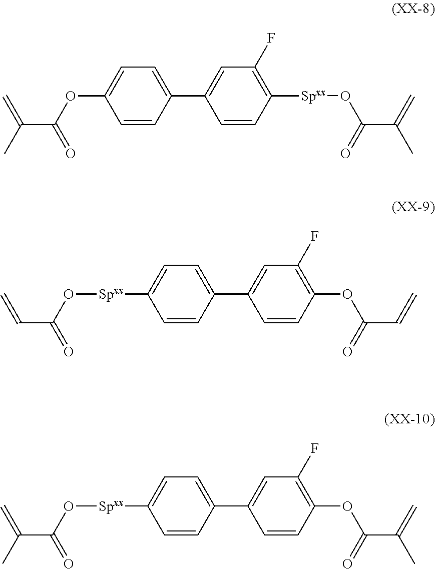

In formula (XX-1) to general formula (XX-10), Sp^{xx} represents an alkylene group having 1 to 8 carbon atoms or —O—(CH₂)ₛ— (in the formula, s represents an integer of 2 to 7 and the oxygen atom is to bond to a ring).

Hydrogen atoms in the 1,4-phenylene groups in formula (XX-1) to general formula (XX-10) may each be substituted with any one selected from —F, —Cl, —CF₃, —CH₃, and formula (R-1) to formula (R-15).

When n²⁰¹ in general formula (M) is 1, polymerizable compounds represented by formula (M31) to formula (M48) are preferable, for example.

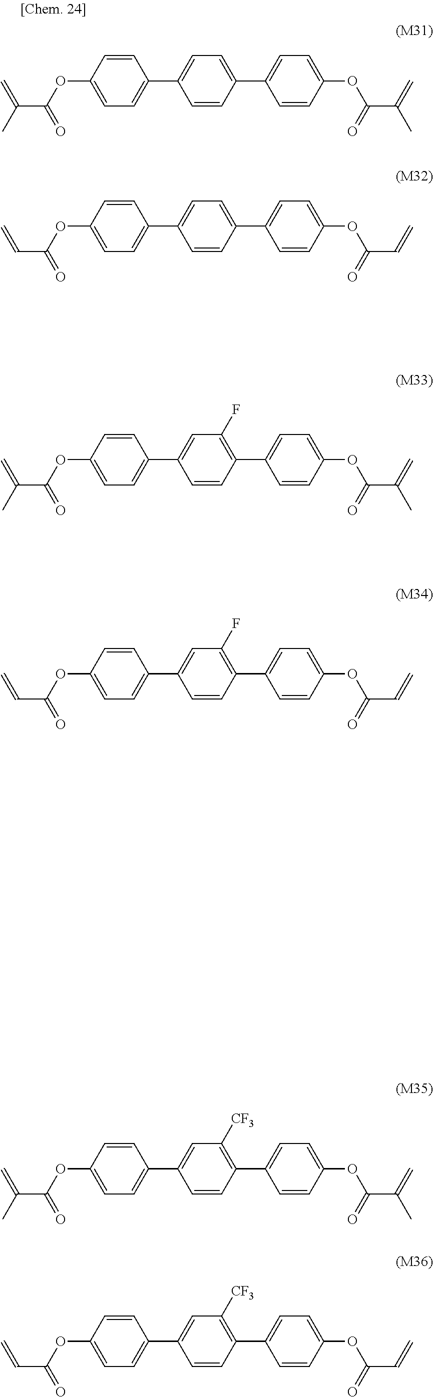

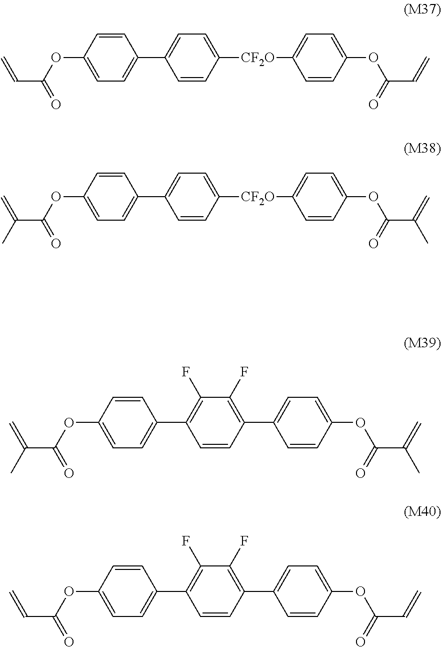

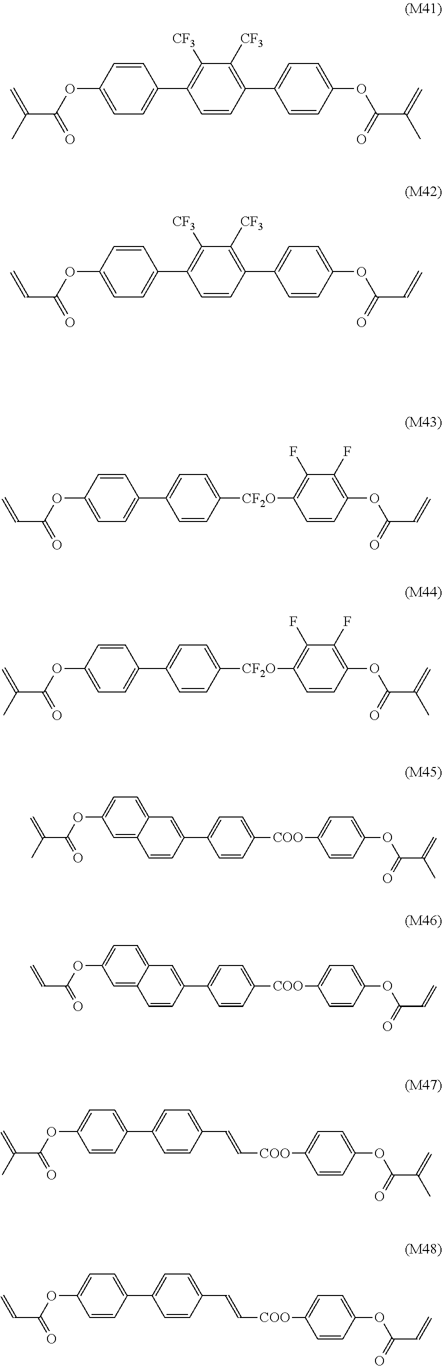

Hydrogen atoms in the 1,4-phenylene groups and naphthalene groups in formula (M31) to formula (M48) may each be substituted with any one selected from —F, —Cl, —CF₃, —CH₃, and formula (R-1) to formula (R-15).

The polymerizable compounds represented by general formula (M) including these skeletons exhibit optimum anchoring force for PSA-mode liquid crystal display devices after polymerization and a satisfactory alignment state is yielded. Thus, display nonuniformity is suppressed or prevented.

When n²⁰¹ in general formula (M) is 1 and two or more compounds represented by formula (R-1) or formula (R-2) are contained, polymerizable compounds represented by formula (M301) to formula (M316) are preferable, for example.

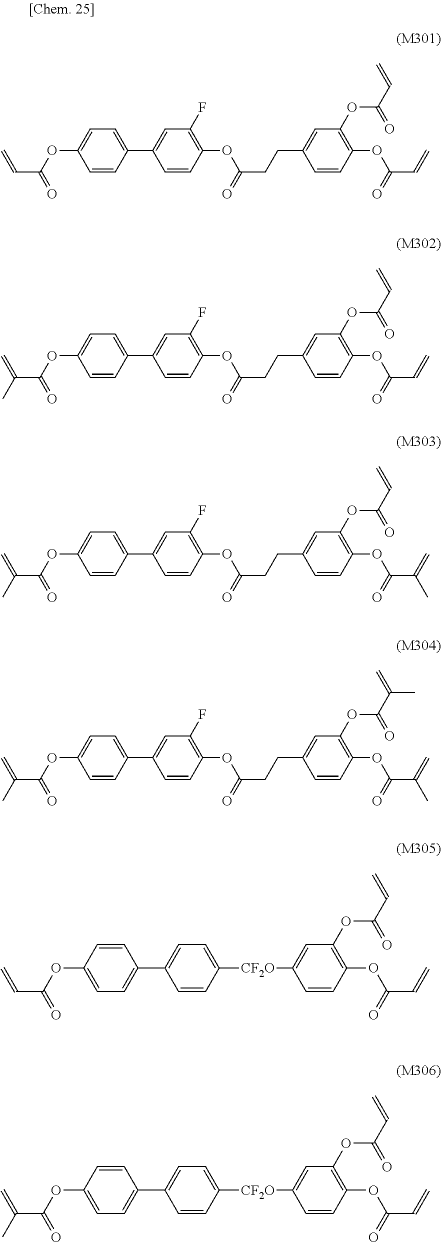

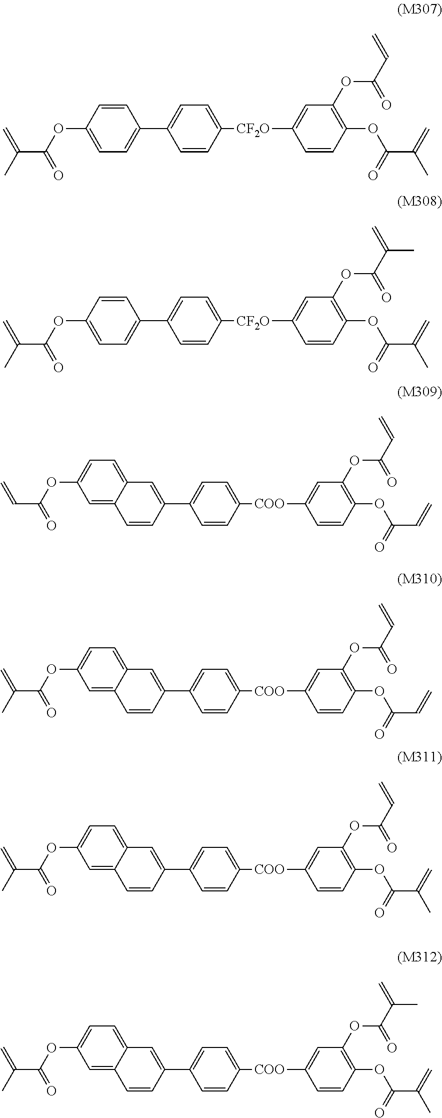

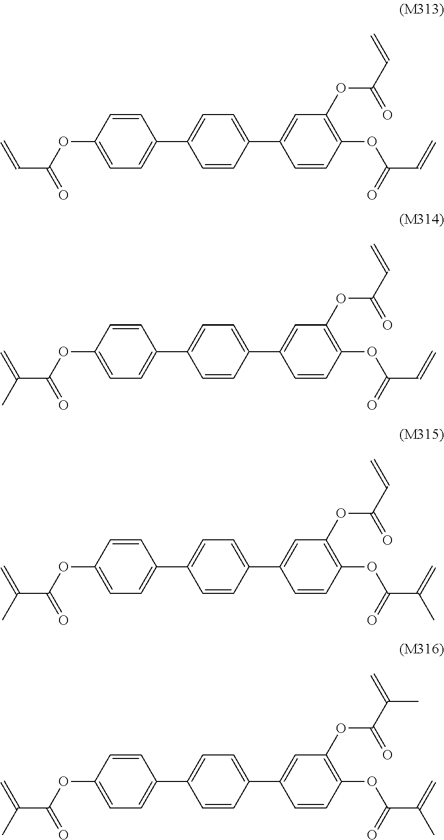

Hydrogen atoms in the 1,4-phenylene groups and naphthalene groups in formula (M301) to formula (M316) may each be substituted with any one selected from —F, —Cl, —CF₃, and —CH₃.

Polymerizable compounds represented by formula (Ia-1) to formula (Ia-31) are preferable as the polymerizable compound represented by general formula (M), for example.

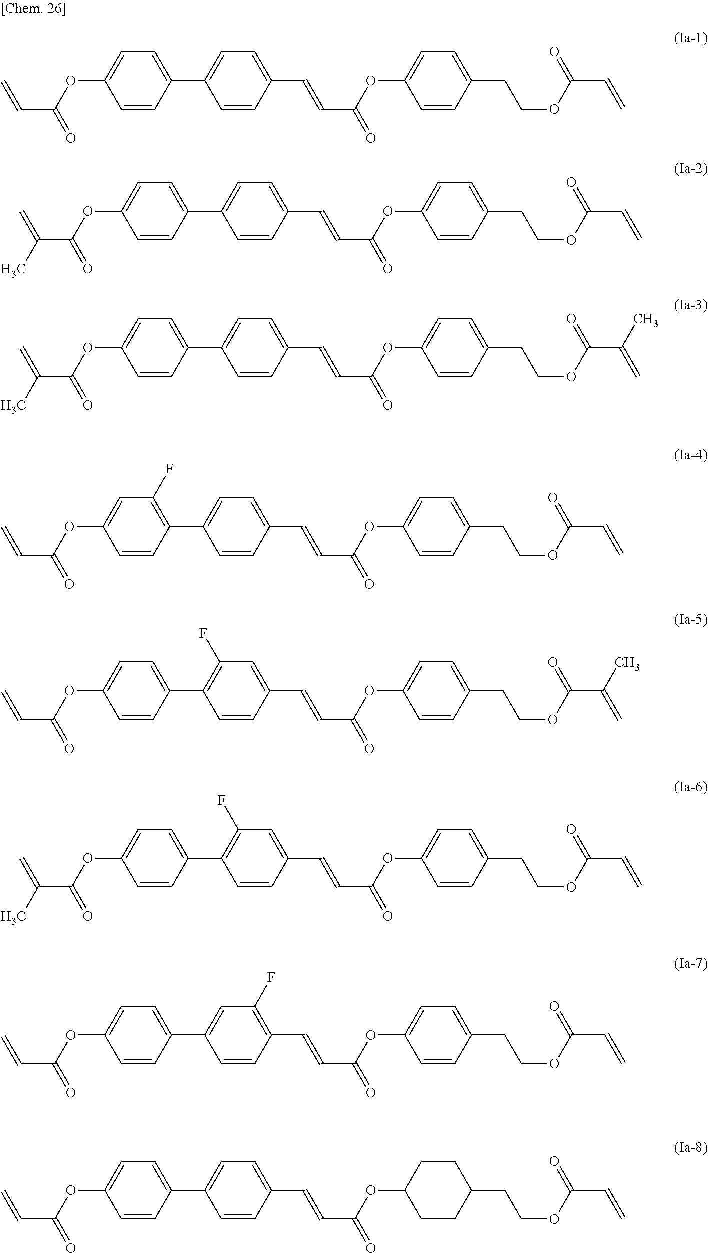

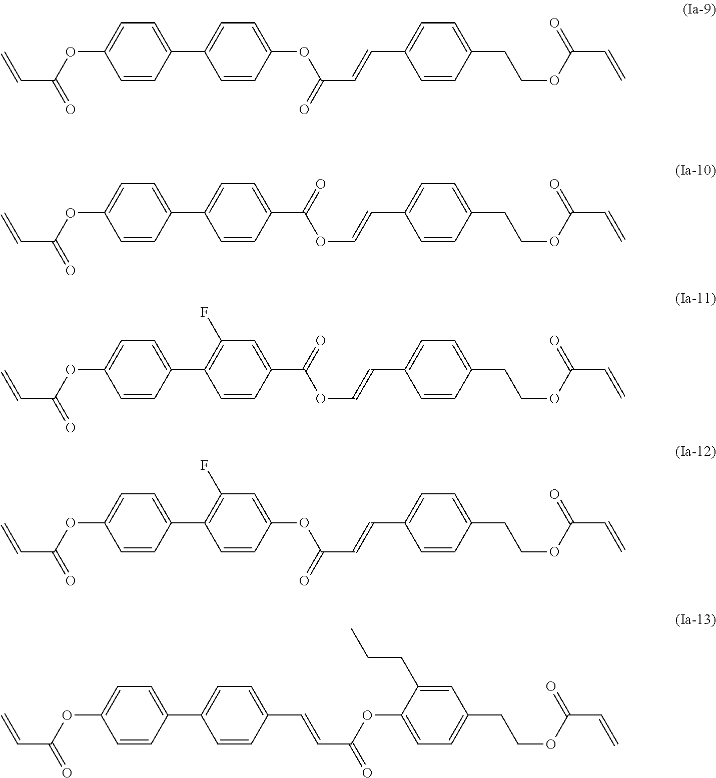

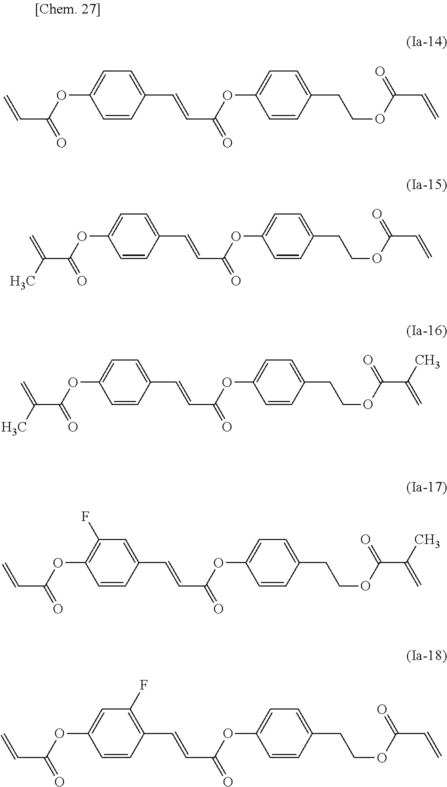

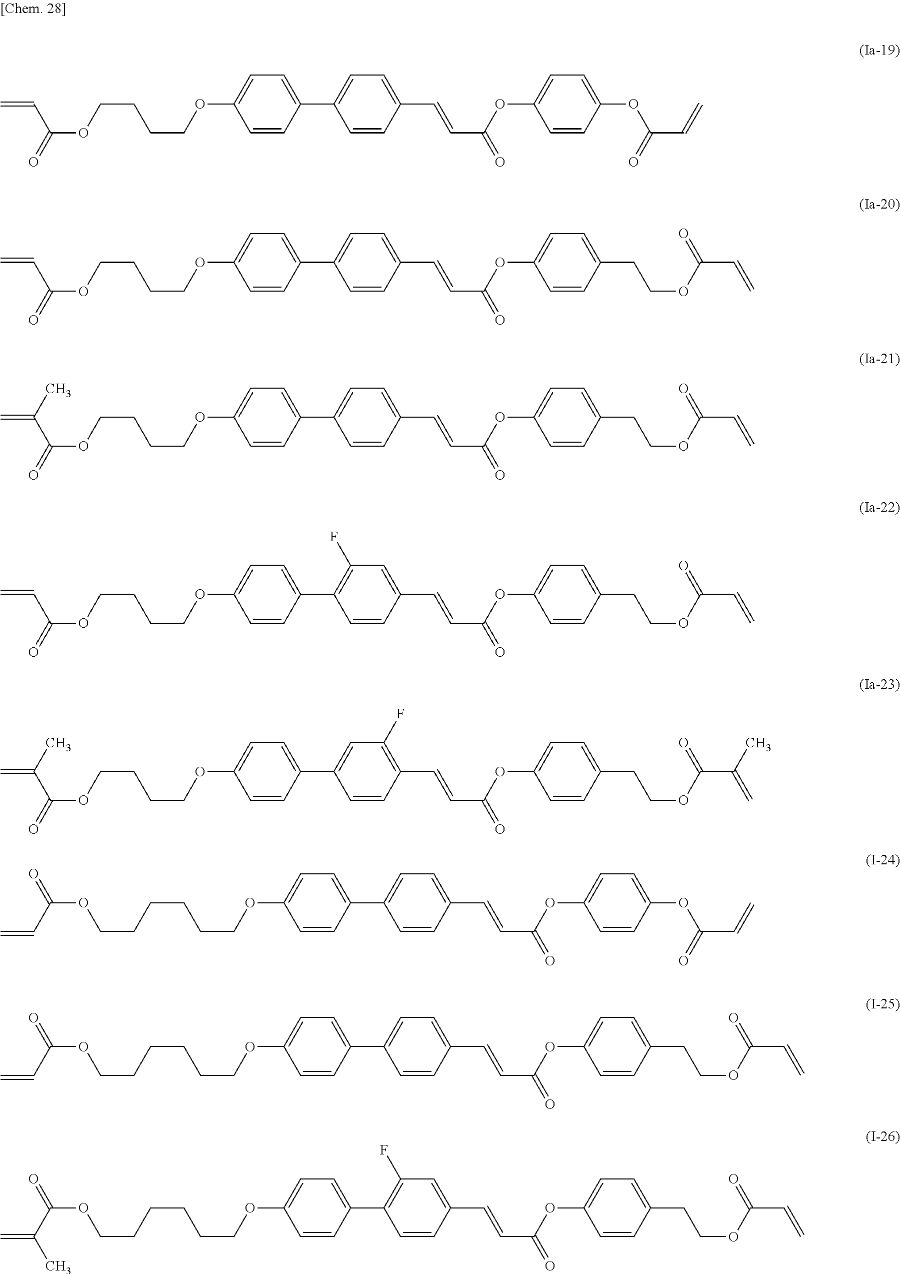

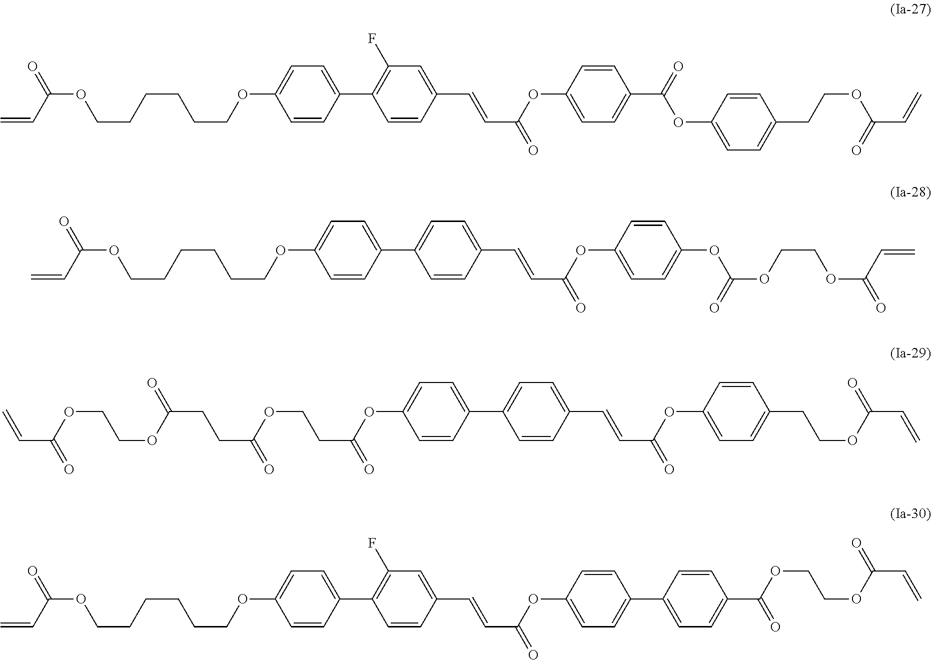

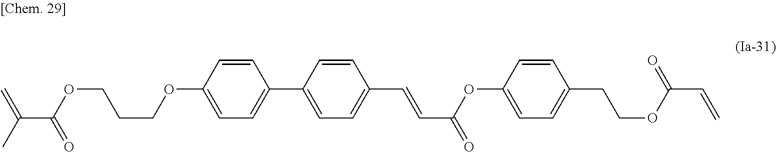

The liquid crystal composition of the present invention more preferably contains one or more polymerizable monomers selected from those described above as the polymerizable monomer. Yet more preferably, the liquid crystal composition contains one or more polymerizable monomers represented by general formula (XX-1), general formula (XX-2), general formula (XX-4), general formula (M-302), and general formula (M31).

The liquid crystal composition of the present invention can contain an antioxidant. Hindered phenol compounds represented by general formula (H-1) to general formula (H-4) are preferable.

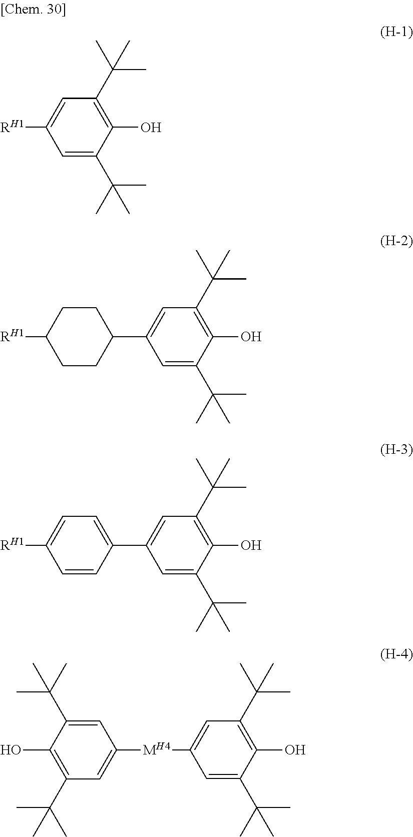

In general formula (H-1) to general formula (H-4), R^{H1} represents an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms; one —CH₂— or two or more nonadjacent —CH₂— in the group may each independently be substituted with —O— or —S—; and one or more hydrogen atoms in the group may each independently be substituted with a fluorine atom or a chlorine atom. In particular, an alkyl group having 2 to 7 carbon atoms, an alkoxyl group having 2 to 7 carbon atoms, an alkenyl group having 2 to 7 carbon atoms, or an alkenyloxy group having 2 to 7 carbon atoms is preferable, and an alkyl group having 3 to 7 carbon atoms or an alkenyl group having 2 to 7 carbon atoms is more preferable.

In general formula (H-4), M^{H4} represents an alkylene group having 1 to 15 carbon atoms (one or more —CH₂— in the alkylene group may be substituted with —O—, —CO—, —COO—, or —OCO— provided that the oxygen atoms are not directly adjacent to each other), —OCH₂—, —CH₂O—, —COO—, —COO—, —CF₂O—, —OCF₂—, —CF₂CF₂—, —CH═CH—COO—, —CH═CH—OCO—, —COO—CH═CH—, —OCO—CH═CH—, —CH═CH—, —C≡C—, a single bond, a 1,4-phenylene group (any hydrogen atom in the 1,4-phenylene group may be substituted with a fluorine atom), or a trans-1,4-cyclohexylene group. M^{H4} preferably represents an alkylene group having 1 to 14 carbon atoms. The number of carbon atoms is preferably 2 to 12, more preferably 3 to 10, yet more preferably 4 to 10, yet more preferably 5 to 10, and most preferably 6 to 10 since the number of carbon atoms is preferably large in view of volatility but not excessively large in view of viscosity.

In general formula (H-1) to general formula (H-4), one —CH═ or two or more nonadjacent —CH═ in the 1,4-phenylene group may each be substituted with —N═. The hydrogen atoms in the 1,4-phenylene group may each independently be substituted with a fluorine atom or a chlorine atom.

In general formula (H-1) to general formula (H-4), one —CH₂— or two or more nonadjacent —CH₂— in the 1,4-phenylene group may each independently be substituted with —O— or —S—. The hydrogen atoms in the 1,4-cyclohexylene group may each independently be substituted with a fluorine atom or a chlorine atom.

Specific examples thereof are those represented by formula (H-11) to formula (H-15).

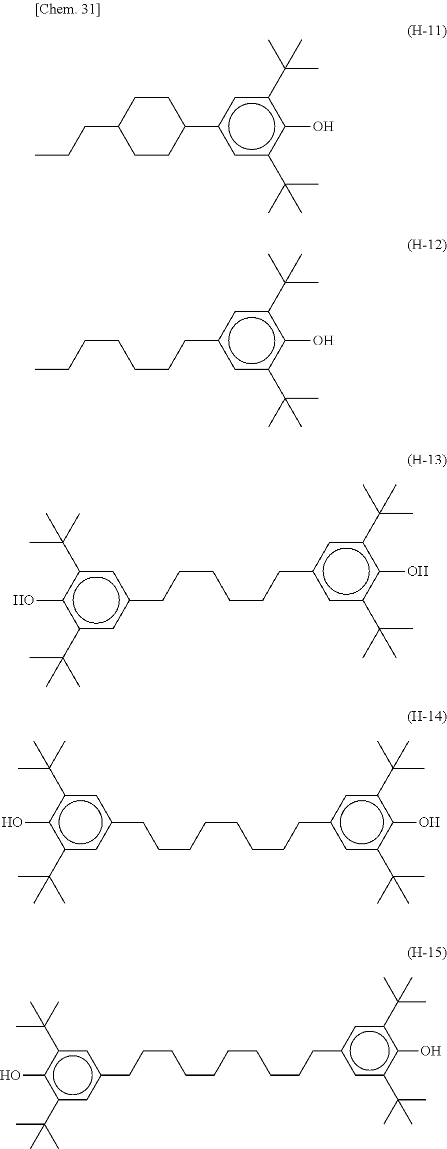

More preferably, the liquid crystal composition of the present invention contains one or more antioxidants represented by formula (H-11) to formula (H-15) as the antioxidants.

The liquid crystal composition of the present invention may contain 1 ppm by mass or more, preferably 10 ppm by mass or more, preferably 20 ppm by mass or more, and preferably 50 ppm by mass or more of the antioxidant. The upper limit of the antioxidant content is 10000 ppm by mass, preferably 1000 ppm by mass, preferably 500 ppm by mass, and preferably 100 ppm by mass.

The liquid crystal display device that uses the liquid crystal composition of the present invention has no or less display failures, high display quality, and high response speed. In particular, the liquid crystal display device can be used in active-matrix-drive VA mode, PSVA mode, PSA mode, IPS mode, FFS mode, or ECB mode.

### Examples

The present invention will now be described in further detailed through examples below which do not limit the present invention. In the compositions of Examples and Comparative Examples below, % means % by mass.

In Examples, following abbreviations are used to describe compounds:

(Side chain)
-n: —CₙH₂₊₁ straight-chain alkyl group having n carbon atoms
n-: CₙH₂ₙ₊₁— straight-chain alkyl group having n carbon atoms
—On: —OCₙH₂₊₁ straight-chain alkoxyl group having n carbon atoms
nO—: CₙH₂ₙ₊₁O— straight-chain alkoxyl group having n carbon atoms

### —V: —CH═CH₂

### V—: CH₂═CH—

### —V1: —CH═CH—CH₃

### 1V—: CH₃—CH═CH—

-2V: —CH₂—CH₂—CH═CH₃
V2-: CH₃═CH—CH₂—CH₂—
-2V1: —CH₂—CH₂—CH═CH—CH₃
1V2-: CH₃—CH═CH—CH₂—CH₂
(Bonding group)

### —CF2O—: —CF₂—O—

### —OCF2-: —O—CF₂—

### -1O—: —CH₂—O—

### —O1-: —O—CH₂—

### —COO—: —COO—

(Ring structure)

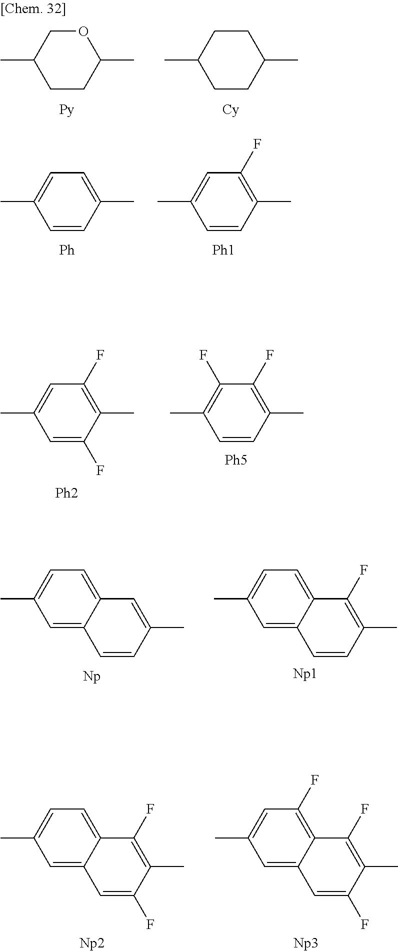

Following properties were measured in Examples.

Tₙᵢ: nematic phase-isotropic liquid phase transition temperature (° C.)
Δn: refractive index anisotropy at 20° C.
Δ∈: dielectric anisotropy at 25° C.
η: viscosity at 20° C. (mPa·s)
γ₁: rotational viscosity (mPa·s) at 20° C.
K₃₃: elastic modulus K₃₃ (pN) at 20° C.

### Comparative Example 1, Example 1, Example 2, and Example 3

Liquid crystal compositions LC-A (Comparative Example 1), LC-1 (Example 1), LC-2 (Example 2), and LC-3 (Example 3) were prepared and physical properties thereof were measured. The constitutions of the liquid crystal compositions and the observed physical properties are shown in Table 1.

TABLE 1

| | | Comparative | | | |
|---|---|---|---|---|---|
| | | Example 1 | Example 1 | Example 2 | Example 3 |
| | | LC-A | LC-1 | LC-2 | LC-3 |
| 3-Cy-Cy-2 | Formula (I-1) | | 13 | 9 | 9 |
| 3-Cy-Cy-V1 | Formula(I-2) | | 10 | 10 | 10 |
| 3-Cy-Cy-V | General formula (III-A) | 12 | | 10 | 12 |
| 3-Cy-Cy-4 | General formula (III-A) | 8 | 5 | | |
| 3-Cy-Ph—O1 | General formula (III-D) | 6 | | | |
| 3-Cy-Ph—O2 | General formula (III-D) | 4 | | | |
| 3-Ph—Ph-1 | General formula (III-F) | 10 | 3 | 8 | 11 |
| 5-Ph—Ph-1 | General formula (III-F) | 5 | 14 | 7 | 2 |
| 3-Cy-Cy-Ph-1 | General formula (III-G) | 7 | 3 | 4 | 5 |
| 3-Cy-Ph—Ph-2 | General formula (III-H) | 2 | | 2 | |
| V-Cy-Ph—Ph-3 | General formula (III-H) | 3 | 6 | 5 | 5 |
| 3-Cy-1O—Ph5—O1 | General formula (II-A1) | 2 | | | |
| 3-Cy-1O—Ph5—O2 | General formula (II-A1) | 6 | 11 | 12 | 4 |
| 1V-Cy-1O—Ph5—O2 | General formula (II-A1) | | | | 4 |
| 2-Cy-Cy-1O—Ph5—O2 | General formula (II-B1) | 12 | 12 | 12 | 12 |
| 3-Cy-Cy-1O—Ph5—O2 | General formula (II-B1) | 12 | 12 | 12 | 12 |
| 4-Cy-Cy-1O—Ph5—O2 | General formula (II-B1) | 2 | 2 | | |
| V-Cy-Cy-1O—Ph5—O2 | General formula (II-B1) | 6 | 3 | 3 | 3 |
| 1V-Cy-Cy-1O—Ph5—O2 | General formula (II-B1) | 3 | 6 | 6 | 3 |
| 3-Cy-Ph5—O2 | General formula (II-A3) | | | | 2 |
| 3-Ph—Ph5—O2 | General formula (II-A4) | | | | 2 |
| 1V3-Ph—Ph5—Ph-3V1 | General formula (V) | | | | 2 |
| 3-Ph—Ph5—Ph-2 | General formula (V) | | | | 2 |

| | | | | |
|---|---|---|---|---|
| Total | 100 | 100 | 100 | 100 |
| Tni [° C.] | 75.8 | 75.5 | 75.1 | 75.9 |
| Δn | 0.100 | 0.100 | 0.100 | 0.101 |
| η [mPa · s] | 17.8 | 15.8 | 14.7 | 14.5 |
| γ1 [mPa · s] | 126 | 113 | 107 | 105 |
| Δε | −3.0 | −3.1 | −3.0 | −3.0 |
| K33 [pN] | 14.1 | 14.3 | 14.5 | 15.2 |
| γ1/K33 | 8.9 | 7.9 | 7.4 | 6.9 |

The liquid crystal compositions LC-1, LC-2, and LC-3 of the present invention had low viscosity (η), low rotational viscosity (γ₁), high elastic modulus (K₃₃), and γ₁/K₃₃ of 7.9, 7.4, and 6.9, respectively, which were smaller than that of liquid crystal composition LC-A of Comparative Example.

Response speed of the liquid crystal display devices that used these liquid crystal compositions was measured. LC-1, LC-2, and LC-3 exhibited sufficiently high response speed, which was faster than LC-A by at least 10%. The cell thickness was 3.5 μm, the alignment film was JALS2096, and the measurement conditions for response speed were Von: 5.5 V, Voff: 1.0 V, measurement temperature: 20° C. DMS301 produced by AUTRONIC-MELCHERS was used in measurement.

A PSVA-mode liquid crystal display device was produced by using a liquid crystal composition containing 99.6% by mass of LC-1 and 0.4% by mass of a polymerizable monomer represented by formula (XX-2). The device had no display failures but sufficiently high response speed.

A PSVA-mode liquid crystal display device was produced by using a liquid crystal composition containing 99.6% by mass of LC-1 and 0.4% by mass of a polymerizable monomer represented by formula (XX-4). The device had no display failures but sufficiently high response speed.

A PSVA-mode liquid crystal display device was produced by using a liquid crystal composition containing 99.6% by mass of LC-1 and 0.4% by mass of a polymerizable monomer represented by formula (M-302). The device had no display failures but sufficiently high response speed.

A PSVA-mode liquid crystal display device was produced by using a liquid crystal composition containing 99.6% by mass of LC-1, 0.3% by mass of a polymerization monomer represented by formula (XX-4), and 0.1% by mass of a polymerization monomer represented by formula (Ia-31). The device had no display failures but sufficiently high response speed.

PSVA-mode liquid crystal display devices were prepared in the same manner as described above by using LC-2 and LC-3 and polymerizable monomers. The devices had no display failures but sufficiently high response speed.

### Comparative Example 2, Example 4, and Example 5

Liquid crystal compositions LC-B (Comparative Example 2), LC-4 (Example 4), and LC-5 (Example 5) were prepared and physical properties thereof were measured. The constitutions of the liquid crystal compositions and the physical properties are shown in Table 2.

TABLE 2

| | | Comparative | | |
|---|---|---|---|---|
| | | Example 2 | Example 4 | Example 5 |
| | | LC-B | LC-4 | LC-5 |
| 3-Cy-Cy-2 | Formula (I-1) | 18 | 14 | 9 |
| 3-Cy-Cy-V1 | Formula(I-2) | — | 8 | 11 |
| 3-Cy-1O—Ph5—O2 | General formula (II-A1) | — | — | 3 |
| 3-Cy-Ph5—O2 | General formula (II-A3) | 3 | 8 | 7 |
| 3-Ph—Ph5—O2 | General formula (II-A4) | 3 | 3 | — |
| 2-Cy-Cy-1O—Ph5—O2 | General formula (II-B1) | — | — | 3 |
| 2-Cy-Cy-Ph5—O1 | General formula (II-B4) | 11 | 10 | 10 |
| 2-Cy-Cy-Ph5—O2 | General formula (II-B4) | 11 | 10 | 10 |
| 3-Cy-Cy-Ph5—O2 | General formula (II-B4) | 11 | 10 | 6 |
| 3-Cy-Ph—Ph5—O2 | General formula (II-B5) | 3 | 4 | 4 |
| 3-Cy-Ph—Ph5—O3 | General formula (II-B5) | 3 | 4 | 4 |
| 3-Cy-Cy-4 | General formula (III-A) | 8 | 4 | — |
| 3-Cy-Cy-V | General formula (III-A) | 3 | 6 | 9 |
| 5-Cy-Cy-V | General formula (III-A) | 3 | — | — |
| 3-Cy-Cy-V1 | General formula (III-A) | — | — | 3 |
| 3-Ph—Ph-1 | General formula (III-F) | 5 | 3 | 3 |
| 5-Ph—Ph-1 | General formula (III-F) | — | — | — |
| 3-Cy-Cy-Ph-1 | General formula (III-G) | — | — | 2 |
| 3-Ph—Ph5—Ph-1 | General formula (V) | 6 | 4 | 5 |
| 3-Ph—Ph5—Ph-2 | General formula (V) | 10 | 10 | 6 |
| 1V2-Ph—Ph5—Ph-2V1 | General formula (V) | 2 | 2 | 5 |

| | | | |
|---|---|---|---|
| Total | 100 | 100 | 100 |
| Tni [° C.] | 82 | 82 | 85 |
| Δn | 0.112 | 0.113 | 0.114 |
| η [mPa · s] | 21.6 | 19.5 | 18.9 |
| γ1 [mPa · s] | 117 | 110 | 107 |
| Δε | −2.7 | −2.8 | −2.7 |
| K33 [pN] | 12.1 | 14.5 | 14.5 |
| γ1/K33 | 9.7 | 7.6 | 7.4 |

The liquid crystal compositions LC-4 and LC-5 of the present invention had low viscosity (fl), low rotational viscosity (γ₁), high elastic modulus (K₃₃), and γ₁/K₃₃ of 7.6 and 7.4, respectively, which were smaller than that of liquid crystal composition LC-B of Comparative Example.

Response speed of the liquid crystal display devices that used these liquid crystal compositions was measured. LC-4 and LC-5 exhibited sufficiently high response speed, which was faster than LC-B by at least 15%. The cell thickness was 3.3 μm, the alignment film was JALS2096, and the measurement conditions for response speed were Von: 5.5 V, Voff: 1.0 V, measurement temperature: 20° C. DMS301 produced by AUTRONIC-MELCHERS was used in measurement.

A PSVA-mode liquid crystal display device was produced by using a liquid crystal composition containing 99.6% by mass of LC-4 and 0.4% by mass of a polymerizable monomer represented by formula (XX-1). The device had no display failures but sufficiently high response speed.

A PSVA-mode liquid crystal display device was produced by using a liquid crystal composition containing 99.6% by mass of LC-4 and 0.4% by mass of a polymerizable monomer represented by formula (XX-2). The device had no display failures but sufficiently high response speed.

A PSVA-mode liquid crystal display device was produced by using a liquid crystal composition containing 99.5% by mass of LC-4 and 0.5% by mass of a polymerizable monomer represented by formula (M-302). The device had no display failures but sufficiently high response speed.

A PSVA-mode liquid crystal display device was produced by using a liquid crystal composition containing 99.6% by mass of LC-4, 0.2% by mass of a polymerization monomer represented by formula (XX-1), and 0.2% by mass of a polymerization monomer represented by formula (XX-2). The device had no display failures but sufficiently high response speed.

A PSVA-mode liquid crystal display device was produced by using a liquid crystal composition containing 99.7% by mass of LC-5 and 0.3% by mass of a polymerizable monomer represented by formula (M31). The device had no display failures but sufficiently high response speed.

A PSVA-mode liquid crystal display device was produced by using a liquid crystal composition containing 99.65% by mass of LC-5 and 0.35% by mass of a polymerizable monomer represented by formula (M33). The device had no display failures but sufficiently high response speed.

The results described above confirm that the liquid crystal compositions of the present invention exhibit sufficiently low viscosity (η), sufficiently low rotational viscosity (γ₁), high elastic modulus (K₃₃), and negative dielectric anisotropy (Δ∈) with a large absolute value without decreasing refractive index anisotropy (Δn) and nematic phase-isotropic liquid phase transition temperature (Tₙᵢ), and that the liquid crystal display devices of VA-mode, PSVA-mode, and PSA-mode that use the liquid crystal composition have high display quality and high response speed.

1. A liquid crystal composition comprising:
a compound represented by formula (I-1) as a first component 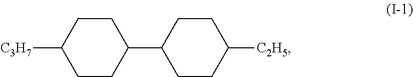
a compound represented by formula (I-2) as a second component 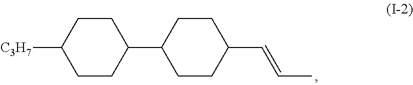
and a compound having negative dielectric anisotropy (Δ∈) whose absolute value is greater than 3 as a third component.

2. The liquid crystal composition according to claim 1, wherein the liquid crystal composition has a dielectric anisotropy (Δ∈) in the range of −2.0 to −8.0 at 25° C., a refractive index anisotropy (Δn) in the range of 0.08 to 0.14 at 20° C., a viscosity (η) in the range of 10 to 30 mPa·s at 20° C., a rotational viscosity (γ1) in the range of 60 to 130 mPa·s at 20° C., and a nematic phase-isotropic liquid phase transition temperature (Tₙᵢ) in the range of 60° C. to 120° C.

3. The liquid crystal composition according to claim 1, wherein one or more compounds selected from the group consisting of compounds represented by general formula (II-1) and general formula (II-2) are contained as the third component: 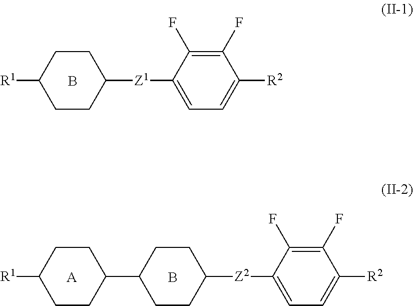
(In the formulae, R¹ and R² each independently represent an alkyl group having 1 to 10 carbon atoms, an alkoxyl group having 1 to 10 carbon atoms, an alkenyl group having 2 to 10 carbon atoms, or an alkenyloxy group having 2 to 10 carbon atoms; one —CH₂— or two or more nonadjacent —CH₂— in R¹ and R² may each independently be substituted with —O— and/or —S—; one or more hydrogen atoms in R¹ and R² may each independently be substituted with a fluorine atom or a chlorine atom; ring A and ring B each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; and Z¹ and Z² each independently represent —OCH₂—, —CH₂O—, —CF₂O—, —OCF₂—, —CH₂CH₂—, —CF₂CF₂—, or a single bond).

4. The liquid crystal composition according to claim 1, comprising, as a fourth component, one or more compounds selected from the group consisting of compounds represented by general formula (III-A) to general formula (III-J): 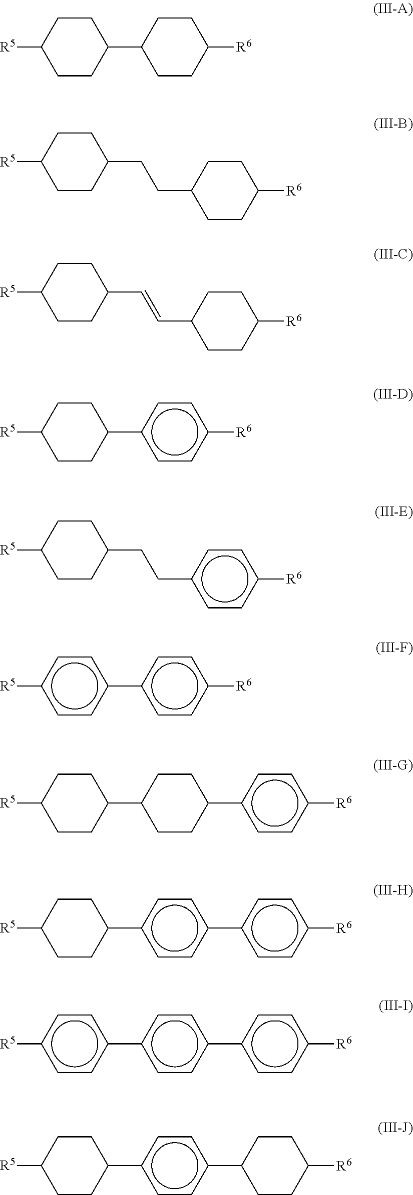
(In the formulae, R⁵ represents an alkyl group having 1 to 5 carbon atoms or an alkenyl group having 2 to 5 carbon atoms; R⁶ represents an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; and compounds represented by general formula (III-A) do not include the same compounds as those represented by formula (I-1) and formula (I-2)).

5. The liquid crystal composition according to claim 3, wherein a compound represented by general formula (II-1) and a compound represented by general formula (II-2) are contained simultaneously.

6. The liquid crystal composition according to claim 3, wherein general formula (II-1) is general formula (II-A1) to general formula (II-A4): 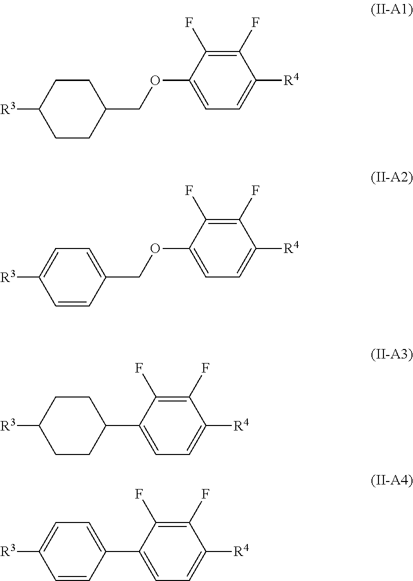
(In the formulae, R³ and R⁴ are each independently the same as R¹ and R²) and general formula (II-2) is general formula (II-B1) to general formula (II-B6): 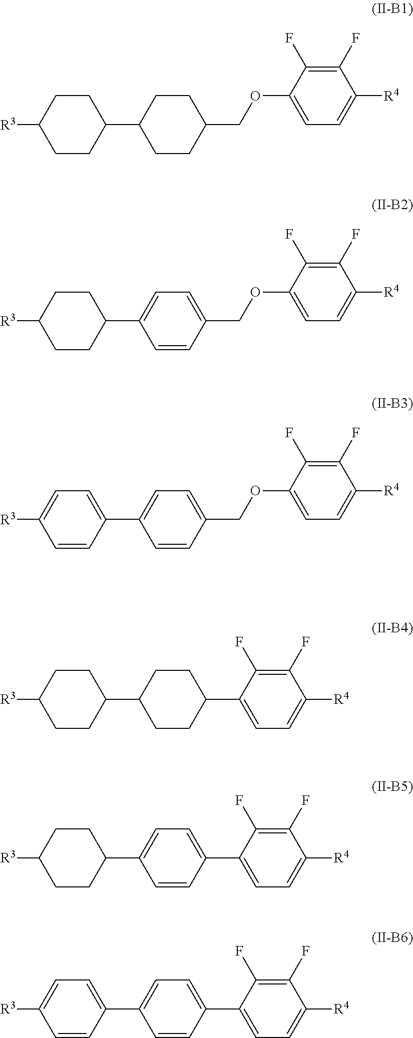
(In the formulae, R³ and R⁴ are each independently the same as R¹ and R²).

7. The liquid crystal composition according to claim 3, comprising one or more compounds selected from the group consisting of compounds represented by general formula (II-1) and general formula (II-2) with R¹ representing a propenyl group.

8. The liquid crystal composition according to claim 1, comprising one or more polymerizable compounds.

9. The liquid crystal composition according to claim 8, wherein the polymerizable compounds are represented by general formula (M): 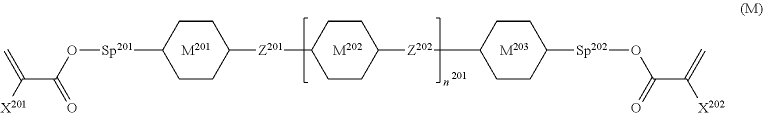
(In the formula, X²⁰¹ and X²⁰² each independently represent a hydrogen atom, a methyl group, or a —CF₃ group; Sp²⁰¹ and Sp²⁰² each independently represent a single bond, an alkylene group having 1 to 8 carbon atoms, or —O—(CH₂)₈— (where s represents an integer of 2 to 7 and the oxygen atom is to bond to a ring); ring M²⁰¹, ring M²⁰², and ring M²⁰³ each independently represent a trans-1,4-cyclohexylene group (one —CH₂— or two or more nonadjacent —CH₂— in the group may each be substituted with —O— or —S—), a 1,4-phenylene group (one —CH═ or two or more nonadjacent —CH═ in the group may each be substituted with —N═), a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and hydrogen atoms in the group may be each independently substituted with a fluorine atom, a —CF₃ group, an alkyl group having 1 to 10 carbon atoms, an alkoxyl group having 1 to 10 carbon atoms, or any one of groups represented by formula (R-1) to formula (R-15): 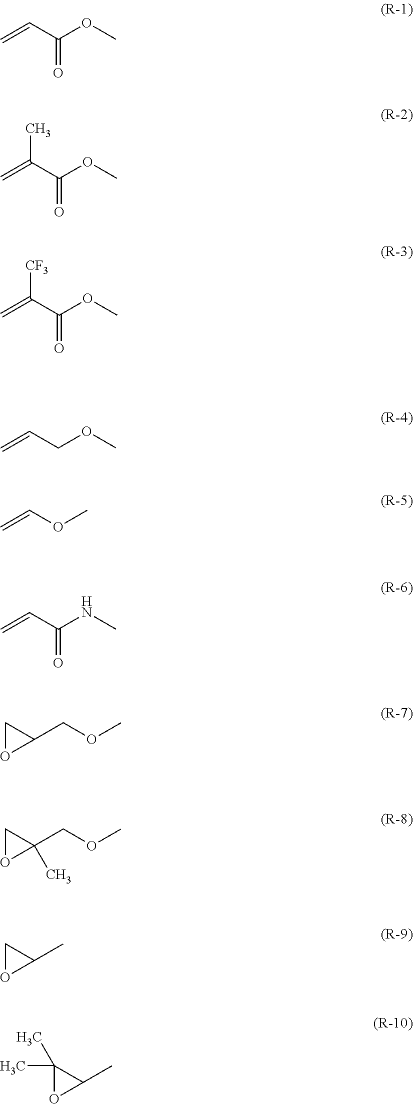 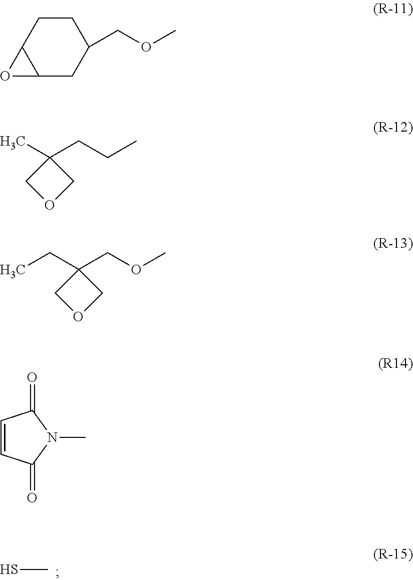
Z²⁰¹ and Z²⁰² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond; n²⁰¹ represents 0, 1, or 2; and when there are two or more rings M²⁰² and two or more Z²⁰², they may each be the same or different).

10. A liquid crystal display device that uses the liquid crystal composition according to claim 1.

11. An active-matrix-driving liquid crystal display device that uses the liquid crystal composition according to claim 1.

12. A VA-mode, PSA-mode, PSVA-mode, IPS-mode, or ECB-mode liquid crystal display device that uses the liquid crystal composition according to claim 1.
